(19) United States
(12) Patent Application Publication
(10) Pub. No.: US 2010/0095203 A1
(43) Pub. Date: Apr. 15, 2010

(54) METHOD AND APPARATUS FOR INCORPORATING VISUAL DELTAS FOR NEW DOCUMENTS BASED ON PREVIOUS CONSUMPTION

(75) Inventors: John Toebes, Cary, NC (US); Lisa Bobbitt, Cary, NC (US)

Correspondence Address: Patent Capital Group - Cisco, 6119 McCommas, Dallas, TX, 75214, US

(73) Assignee: Cisco Technology, Inc., San Jose, CA (US)

(21) Appl. No.: 12/251,641

(22) Filed: Oct. 15, 2008

(51) Int. Cl. G06F 17/20; G06F 17/30

(52) U.S. Cl. 715/277; 707/E17.058

(57) ABSTRACT

In one embodiment, a method includes obtaining a first document that includes at least a first section, and displaying the first document on a display screen. The method also includes determining when the first section has been consumed. Such a determination includes a determination of whether the first section has been displayed on the display screen. If the first section is determined to have been displayed on the display screen, the method also includes providing an indication that the first section has been consumed.

### BACKGROUND OF THE INVENTION

The present invention relates generally to content networking.

Multiple versions of a document may exist during the lifetime of the document. For example, a document may undergo multiple revisions before a substantially “final” version of the document is effectively completed. The multiple versions of the document which exist during the lifetime of the document may be consumed, e.g., read or edited, by any number of users.

It is often difficult to ensure that everyone who reads a document, particularly a large document, is seeing substantially all of the relevant information in the document. By way of example, if a user has read a section in a previous version of the document, he or she may neglect to re-read that section in a new version of the document. If that section of the document has been revised in the new version, by not re-reading that section upon obtaining the new version, the user would not consume the new content in the section. As such, information that may be important to the user may effectively elude the user despite the user believing that he or she has read an entire document.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a diagrammatic representation of a new document which identifies areas which were previously consumed, e.g., read, while in a previous version of the new document in accordance with an embodiment of the present invention.

FIG. 2 is a process flow diagram which illustrates a method of identifying visual deltas associated with a new document in accordance with an embodiment of the present invention.

FIG. 3 is a process flow diagram which illustrates a method of updating deltas associated with a document as the document is consumed in accordance with an embodiment of the present invention.

FIG. 4 is a process flow diagram which illustrates a method of collecting and processing deltas associated with a document in accordance with an embodiment of the present invention.

FIG. 5 is a diagrammatic representation of a document which identifies areas which have been consumed by various users in accordance with an embodiment of the present invention.

FIG. 6 is a block diagram representation of a system which is configured to collect and to process contextual change information in accordance with an embodiment of the present invention.

FIG. 7 is a process flow diagram which illustrates a method of generally presenting a document which has associated deltas in accordance with an embodiment of the present invention.

### DESCRIPTION OF EXAMPLE EMBODIMENTS

### General Overview

According to one aspect of the present invention, a method includes obtaining a first document that includes at least a first section, and displaying the first document on a display screen. Such a determination includes a determination of whether the first section has been displayed on the display screen. If the first section is determined to have been displayed on the display screen, the method also includes providing an indication that the first section has been consumed.

### Description

The consumption of a document may be determined by tracking multiple versions of the document. In other words, if contextual change information relating to previous versions of a document are tracked and presented with a new version of the document, the amount of the document which has been consumed by one or more users, e.g., readers, of the document may be readily determined.

Contextual change information may include, but is not limited to including, author contribution information, information relating to a number of changes of content in the document, information that indicates which areas or sections of the document are effectively in flux, and information that indicates areas or sections of the document which have been changed since the last time a user consumed those areas or sections. Tracking contextual change information associated with a document improves the efficiency with which a document may be reviewed. By way of example, when contextual change information is visually provided in a new version of document, a reader of the new version may readily identify portions of the new version which he or she read in a previous version of the document. Hence, the reader may be able to focus on portions in the new version which he or she has not already read.

By noting portions of an older document which have been read by a reader, and identifying when a new version of the document becomes available, consumption information and differences, e.g., “deltas,” between the older document and the new version of the document may be presented to the reader. As a result, the reader may be able to determine which portions of the new version he or she may need to read, and which portions of the new version he or she has effectively already read. In one embodiment, the user may also be able to readily identify which portions of the new version are new or changed relative to the older version. The visualization of changes may reduce the amount of time needed by the user to locate and consume new information which he or she has not previously consumed.

When a reader receives a new version of a document he or she has already partially read or, more generally, consumed, he or she may open the new version of the document. Once the new version is opened within a viewing/editing application, the viewing/editing application may locate substantially all previous versions of the document, and then determine which sections of the previous versions have been consumed. Consumption information, e.g., information regarding whether various sections in previous versions have been viewed, may be displayed when the new version is displayed. The viewing/editing application also identifies differences or changes between the previous versions and the new version, and displays an indication of those changes when the new version is displayed.

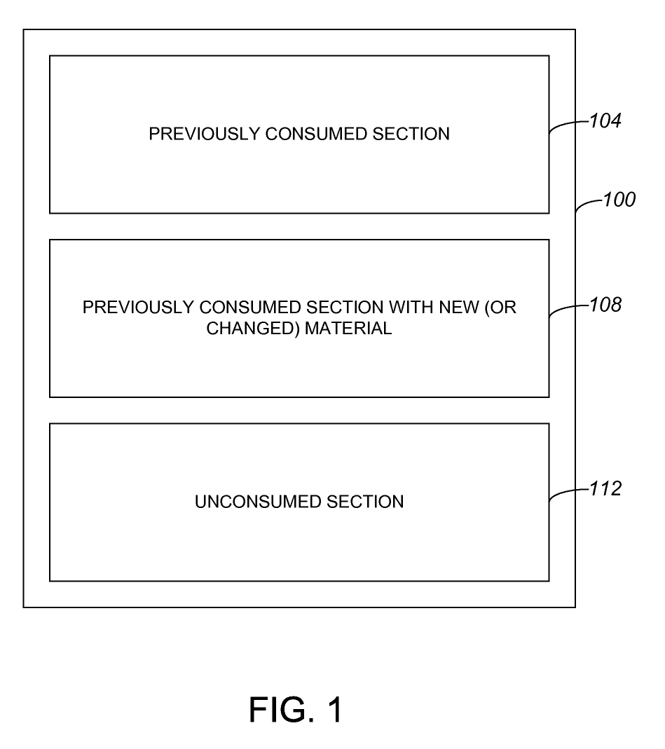

Referring initially to FIG. 1, a new document which includes indications of sections or areas which were previously consumed, e.g., read or viewed, while in a previous version of the new document will be described in accordance with an embodiment of the present invention. A document 100, which may be an editable document which contains text, includes a plurality of different sections 104, 108, 112. In general, both the number of sections 104, 108, 112 and the size of sections 104, 108, 112 may vary depending upon factors which may include, but are not limited to including, user preferences and the size of document 100.

Sections 104, 108, 112 may be considered to be consumed, e.g., viewed or read, when sections 104, 108, 112 correspond to sections of a previous version of document 100 which have previously been displayed on a display screen (not shown). For example, when section 104 has previously been displayed in a window of a display screen (not shown), and section 104 is substantially the same as it was when part of a previous version of document 100, section 104 may be considered to have been previously consumed. As such, section 104 may be displayed on a display screen (not shown) such that section 104 is effectively identifiable as having been previously consumed. Identifying section 104 as having previously been consumed may include, but is not limited to including, highlighting text and/or objects included in section 104 in a particular color, utilizing a particular font size or type for text included in section 104, or otherwise providing a visual indication that is arranged to indicate that the contents of section 104 were previously consumed.

In some instances, a section 108 which was consumed in a previous version of document 100 may be updated in document 100. When section 108 was previously consumed while a part of a previous version of document 100 and currently includes material which is new and/or changed, section 108 may be displayed or otherwise presented such that section 108 is identified as having been previously consumed, but including new or changed material. In one embodiment, section 108 may be highlighted in a different color than used to highlight section 104. Additionally, new or changed material within section 108 may additionally be emphasized, e.g., new or changed material may be underlined or presented in a different color than other material within section 108.

A section 112 within document 100 was not previously consumed, i.e., section 112 is effectively unconsumed. As such, none of the material in section 112 was viewed on a display screen (not shown). Section 112 may generally include material which was not in a previous version of document 100 and/or material which was included in a previous version of document 100 but not displayed on a display screen (not shown). Typically, section 112 may include text or objects that are not highlighted in any way. By way of example, text included in section 112 may be presented substantially as intended, or created, by an author of document 100.

A previously consumed section such as section 104 and a previously consumed section that includes new or changed material such as section 108 are effectively marked as being previously consumed such that a consumer or user of a document may identify sections 104, 108. Differences or deltas between versions of substantially the same document may be presented visually such that a consumer may readily identify the differences. In one embodiment, a delta includes differences as well as consumption information.

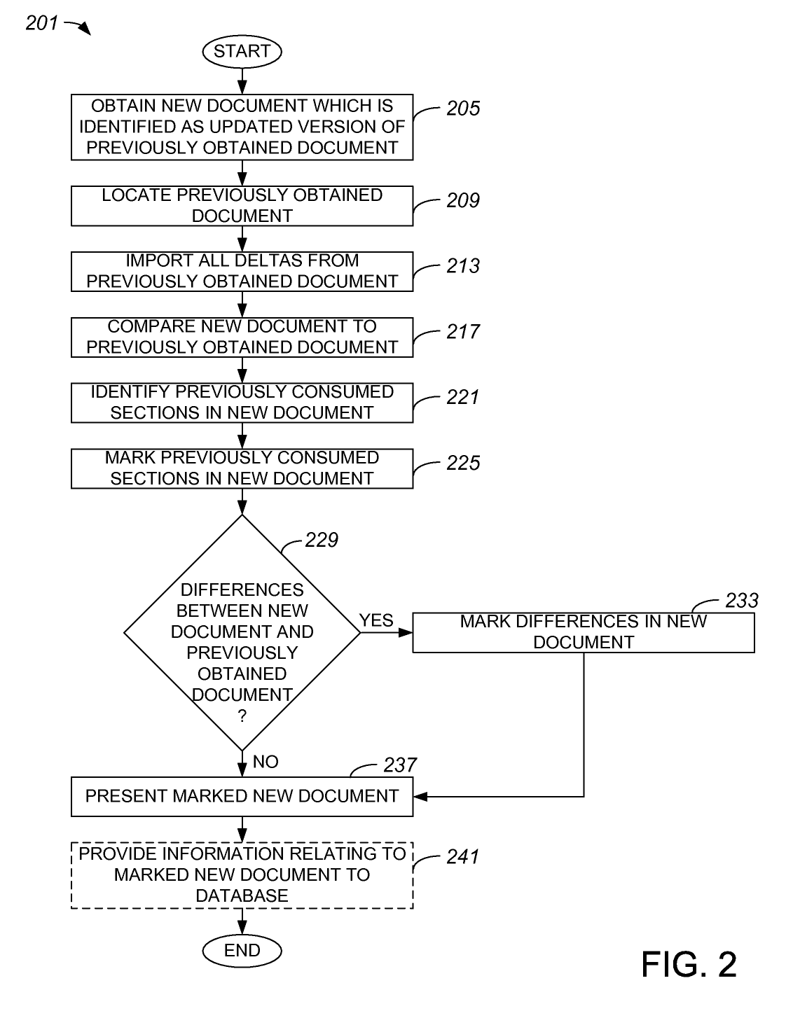

FIG. 2 is a process flow diagram which illustrates a method of identifying visual deltas associated with a new document in accordance with an embodiment of the present invention. In general, a new document is an updated or newer version of a previous or older document that is provided to a user or a consumer. A process 201 of identifying visual deltas associated with a new document begins at step 205 in which the new document is obtained. The new document may be obtained through any suitable method including, but not limited to including, receiving the new document in an email, obtaining the new document through a network connection, and/or obtaining the new document from a tangible medium such as a memory drive.

The new document that is obtained is identifiable as an updated version of a previously obtained document. That is, the new document is arranged to be recognized as a newer version of a previously obtained document. Substantially all older versions of the new document which were previously obtained may be identified as being associated with the new document. In one embodiment, the new document and substantially all previous versions of the document include a unique indicator which identifies the documents as being related. Such an identifier may be a globally universally unique identifier (GUUID). Alternatively, such an identifier may be a title associated with the documents.

Once the new document is obtained, substantially all previously obtained documents which are effectively earlier versions of the new document are located in step 209. In general, the earlier versions of the new document may be stored substantially anywhere, e.g., locally on the system of a user or on a network that may be accessed by the user. While a system may substantially automatically locate previous versions of the new document, it should be appreciated that a user may instead be prompted to provide information which allows the previous versions to be located.

After an earlier version of the new document is obtained, substantially all deltas associated with the earlier version or previously obtained document are imported in step 213. Importing the deltas generally includes associating the deltas with the new document such that the deltas may be represented visually in a visual rendering of the new document. In one embodiment, importing the deltas may include importing information regarding whether the sections in the earlier version were consumed, as the consumption information is included in the deltas, as discussed above.

In step 217, the new document is compared with the previously obtained document. Then, in step 221, previously consumed sections are identified in the new document. That is, sections in the new document which are substantially the same as corresponding sections in the previously obtained documents which have been consumed are identified. Previously consumed sections are marked in the new document in step 225 as having been consumed. Marking sections in the new document as having been consumed may include setting flags associated with the sections to a “consumed” state.

A determination is made in step 229 as to whether there are any differences, e.g., associated with new deltas, between the new document and the previously obtained document. Such a determination may include ascertaining whether there is at least one difference in content between the previously obtained document and the new document. If the new document includes new material which was not in the previously obtained document, or if the new document does not include some material which was in the previously obtained document, then there is at lest one difference in content between the previously obtained document and the new document.

If there are no differences between the new document and the previously obtained document, the indication is that the new document is substantially the same as the previously obtained document, e.g., in terms of content. As such, in step 237, the marked new document is presented. Presenting the marked new document may include displaying the marked new document such that previously consumed sections, as well as any imported deltas, are highlighted. In other words, the new document may be presented such that deltas based on differences and consumption information may essentially be viewed.

From step 237, process flow moves to an optional step 241 in which information relating to the marked new document is provided to a database. That is, information pertaining to consumed sections, deltas, and other differences may be stored. Storing such information allows a party, as for example an originator or author of the new document, to access the information to determine how much of the new document has been consumed. A database or other structure in which information relating to the marked new document is stored may be local relative to a system used by a consumer of the document, local relative to a system used by an author of the document, or accessible through a network. The process of identifying visual deltas is completed after information is optionally provided to the database.

Returning to step 229, if the determination in step 229 is that there are differences between the new document and the previously obtained document, then the differences are marked in the new document in step 233. Marking the differences may include configuring the new document to visually highlight the differences in the new document and/or setting a flag to indicate that a particular section of the new document includes differences. In one embodiment, marking the differences may include effectively marking a section which was previously consumed as being “changed.” It should be appreciated that the marked differences are effectively associated with deltas. Once the differences are marked, process flow moves to step 237 in which the marked new document is presented.

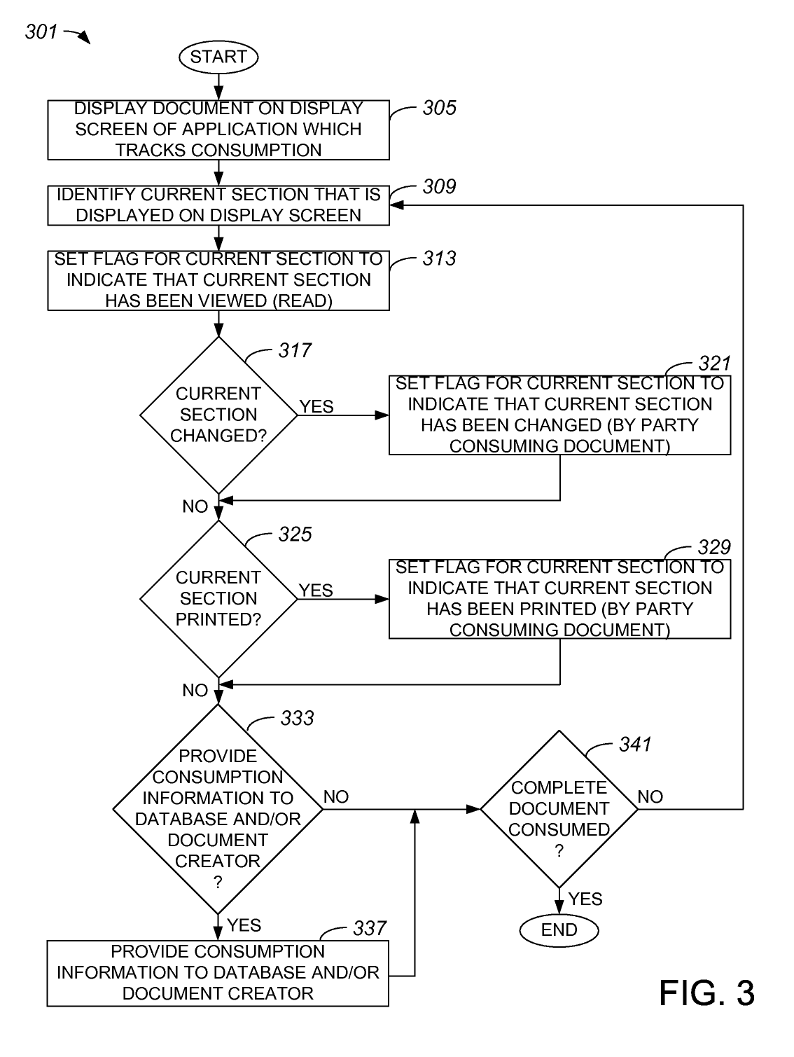

When a document is opened by a consumer or user using an application which allows the document to be viewed, interactions between the consumer and the document may be tracked. Tracking interactions between the consumer and the document allows deltas associated with the document to be created and/or updated. FIG. 3 is a process flow diagram which illustrates a method of updating deltas associated with a document as the document is consumed in accordance with an embodiment of the present invention. A process 301 of updating deltas begins at step 305 in which a document is displayed on a display screen associated with an application which tracks the consumption of the document. An application which tracks the consumption of the document may be a word processing application.

Once the document is displayed or otherwise visually presented, a current section that is displayed on the display screen is identified in step 309. A current section of the document that is displayed on the display screen may be identified by the application which tracks consumption of the document. The current section, in one embodiment, is a paragraph that is displayed on the display screen.

In step 313, the current section is effectively marked to indicate that the current section has been viewed, e.g., read. For example, a flag which is associated with the current section and has a “viewed” state and an “unviewed” state may be set to a “viewed” state to indicate that the current section has been viewed. It should be appreciated that in some embodiments, the amount of time a current section has been displayed on the display screen may be accounted for in assessing whether the current section has been viewed.

After the flag is set in step 313, it is determined in step 317 whether the current section has changed. In other words, it is determined whether the consumer who is viewing the document has edited the document. If it is determined that the current section has not been changed, a flag which indicates whether or not the current section has been changed is not set, and a determination is made in step 325 whether the current section has been printed. In one embodiment, if the current section has been printed, the indication is that the current section has at least been scanned or lightly read.

If the determination in step 325 is that the current section has not been printed, a flag which is arranged to indicate whether the current section has been printed is not set. Then, process flow moves to step 333 in which it is determined whether the consumption information, e.g., information pertaining to the various flags, is to be provided to a database and/or to the creator of the document. Providing consumption information to a database and/or a document creator allows the document creator to readily access the information and, hence, to identify whether the consumer has read or edited the document.

When the determination in step 333 is that consumption information is not to be provided to a database and/or a document creator, then it is determined in step 341 whether the complete document has been consumed. Such a determination may include determining whether substantially every section in the document has been consumed, e.g., viewed. In one embodiment, if every section of the document has been printed, the complete document may be considered as having been completely consumed. In such an embodiment, flags for every section of the document that has been printed may be set to indicate that those sections have been printed during a printing process.

If it is determined in step 341 that the complete document has been consumed, the process of updating deltas is completed. Alternatively, if it is determined that the complete document has not been consumed, the indication is that at least some one section has neither been viewed nor printed, then process flow returns to step 309 in which the current section that is displayed on the display screen is identified.

Returning to step 333, if it is determined that consumption information is to be provided to a database and/or a document creator, the consumption information is provided to the database and/or the document creator in step 337. Once the consumption information is provided, it is determined in step 341 whether the completed document has been consumed.

Referring back to step 325 and the determination of whether the current section has been printed, if it is determined that the current section has been printed, a flag that indicates whether the current section has been printed is set to indicate that the current section has been printed in step 329. After the flag is set to indicate that the current section has been printed, process flow moves to step 333 in which it is determined whether consumption information is to be provided to a database and/or a document creator.

Returning to step 317, if it is determined that the current section has been changed, the indication is that the consumer has edited the current section or otherwise made changes which affect the current section. Accordingly, in step 321, a flag which indicates whether the current section has been changed is set to indicate that the current section has been changed. Once the flag is set to indicate a “changed” state for the current section, a determination is made in step 325 as to whether the current section has been printed.

It should be understood that a user or a reader of a document may never be completely finished reading the document. By way of example, a user may read an entire document and then re-open the document to make changes. If the user re-reads a previously read document, flags may be set to identify previously read sections as having been edited during the re-reading process.

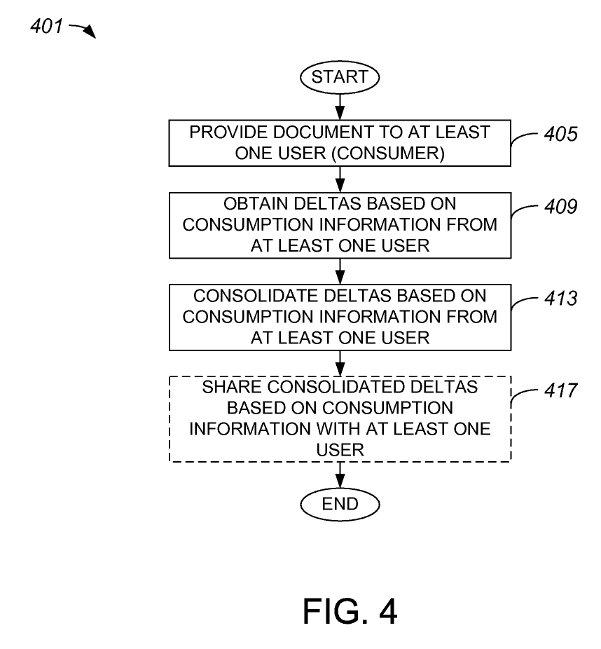

A creator or originator of a document may collect and process consumption information associated with the document from users who consume the document. Using deltas associated with the document which are based on consumption information, the creator may identify sections of the document which have been consumed, and may also identify sections of the document that have been changed. FIG. 4 is a process flow diagram which illustrates a method of collecting and processing deltas based on previous consumption information, as well as other information, in accordance with an embodiment of the present invention. A process 401 of collecting and processing deltas based on previous consumption information begins at step 405 in which a creator provides a document to at least one user or consumer. After the document is provided to at least one user, the creator obtains deltas based on previous consumption information from at least one user in step 409. Typically, the creator obtains deltas from substantially all users that the document was provided to. It should be appreciated that if a user has not opened or otherwise accessed the document, the consumption information from such a user may indicate that the document has not been opened.

In step 413, the creator consolidates the deltas obtained from at least one user. Consolidating the deltas often includes creating augmented document which includes the document, and presents the deltas. The augmented document may, for example, show the document such that sections are identified, and also such that information which indicates whether a user has consumed the sections is presented. The augmented document may also show changes made by a user.

The consolidated deltas may optionally be shared with at least one user in step 417. By way of example, the creator may elect to provide the augmented document to all consumers of the document. The process of collecting and processing deltas based on previous consumption information is completed upon optionally sharing the deltas.

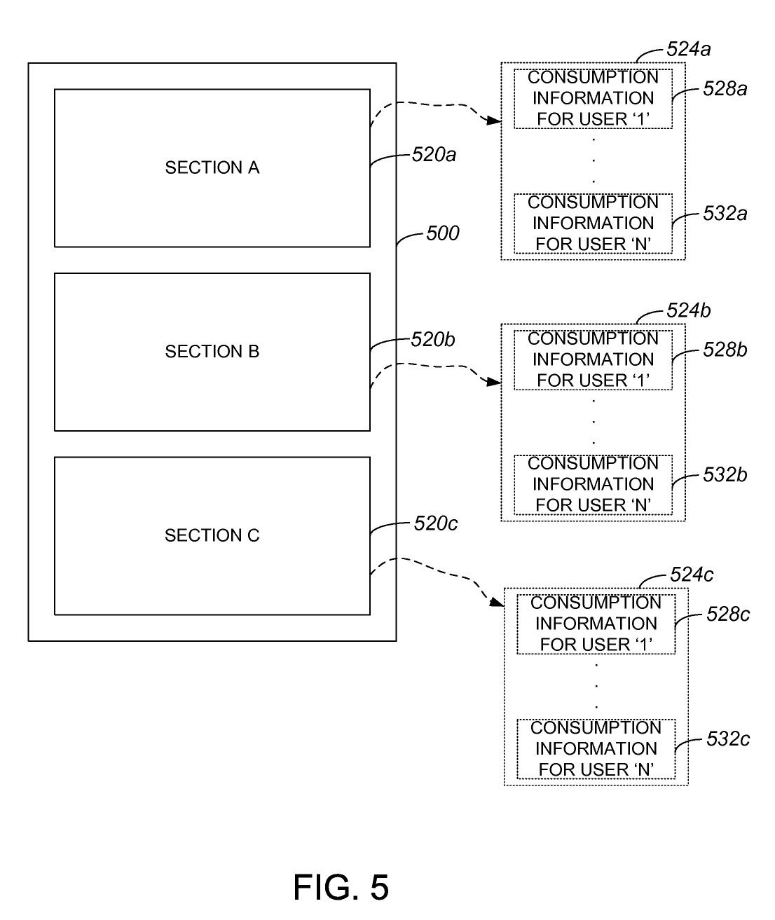

Consolidated deltas or consumption information for multiple consumers or users may be stored or maintained in a document file such that the consumption information is available with a document. With reference to FIG. 5, an augmented document which includes consumption information for various consumers will be described in accordance with an embodiment of the present invention. An augmented document 500 includes a number of sections 520a-c. Each section 520a-c has an associated data structure 524a-c in which consumption information pertaining to each user or consumer associated with document 500 may be stored. Such information may be stored, for example, in a file connected to or otherwise associated with document 500, or in a database that is stored either locally with respect to a user or on a network. A data structure 524a is arranged to store consumption information 528a, 532a that pertains to section 520a, a data structure 524b is arranged to store consumption information 528b, 532b that pertains to section 520b, and a data structure 524c is arranged to store consumption information 528c, 532c that pertains to section 520c.

Each data structure 524a-c is arranged to store consumption information for each user that document 500 has been provided to. For example, consumption information 528a relating to the consumption of section 520a by a first user may be stored in data structure 524a, along with consumption information 532a relating to the consumption of section 520a by a second user.

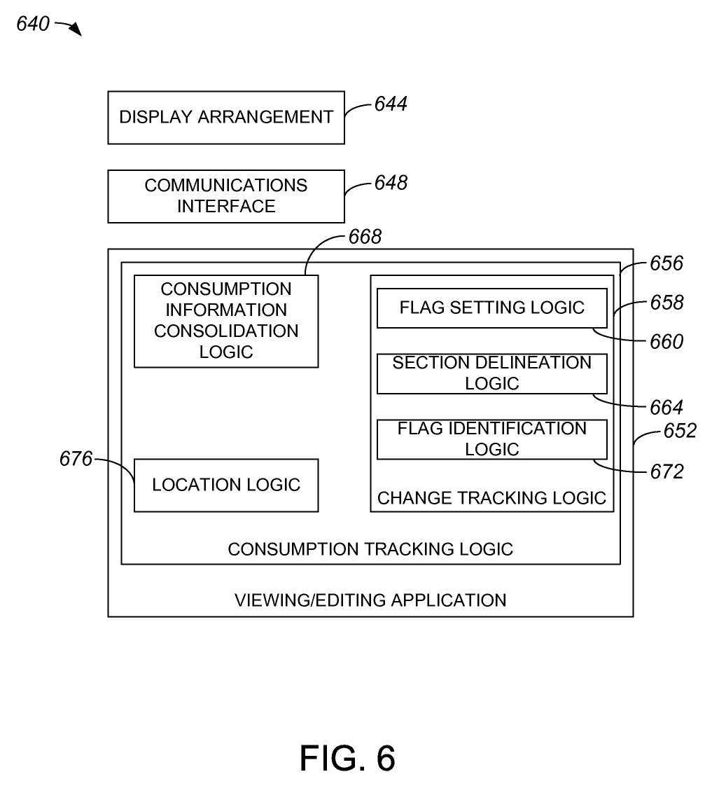

An application which maintains consumption information and presents visual deltas may be included on computing systems associated with consumers and on computing systems associated with document creators. FIG. 6 is a block diagram representation of a system which is configured to collect and to process contextual change information in accordance with an embodiment of the present invention. A system 640, which is generally a computing system, includes a display arrangement 644 which is configured to display or otherwise present a document with consumption information and/or visual deltas. System 640 also includes a communications interface 648 that is arranged to enable system 640 to communicate with other systems (not shown). Communications interface 648 may include at least one input/output port and a network connection that allows system 640 to communicate across a network.

A viewing/editing application 652, e.g., a word processing application or a document generating application, is included in system 640. Viewing/editing application 652 is generally arranged to enable a document to be created and edited. In the embodiment as shown, viewing/editing application 652 includes consumption tracking logic 656. Consumption tracking logic 656 generally includes change tracking logic 658, consumption information consolidation logic 668, and location logic 676. Consumption tracking logic 656 may be provided as a macro or a plug-in used by viewing/editing application 652.

Change tracking logic 658 is arranged to track changes between different versions of a document, as well as within a document. Change tracking logic 658 includes flag setting logic 660, section delineation logic 664, and flag identification logic 672. Flag setting logic 660 is arranged to determine when flags are to be set with respect to sections in a document, and to set flags as appropriate. By way of example, flag setting logic 660 may determine when changes have been made to a particular section in a document, and set a flag to indicate that changes have been made. Section delineation logic 664 is arranged to enable sections to be defined within a document, and to allow flags to be assigned to each section. In general, section delineation logic 664 allows a user of viewing/editing application 652 to determine how sections are to be defined within a document. Flag identification logic 672 is configured to enable flags associated with a document to be processed such that when the document is displayed on display arrangement 644, the flags are substantially accounted for. For instance, if a flag indicates that a particular section has been viewed, then flag identification logic 672 identifies the flag and causes the particular section to be displayed such that the “viewed” status of the particular section is effectively indicated. Flag identification logic 672 may also allow for a flag to be set to indicate a level to which a particular section has been consumed.

Consumption information consolidation logic 668 allows a user of system 640 to consolidate consumption information received or otherwise obtained from various consumers of a document. Consumption information, deltas, and other information obtained from various consumers of a document may be collected, processed, and visually presented using consumption information consolidation logic 668. By way of example, consumption information consolidation logic 668 may enable an augmented document, as previously described with respect to FIG. 5, to be created.

Location logic 676 is configured to allow a previous or otherwise related version of a new document, e.g., a new document received through communications interface 648, to be located when the new document is opened. That is, location logic 676 is arranged to identify older versions of a new document. Location logic 676 may be configured to search system 640 for previous versions of the new document, to search a network of which system 640 is a part for previous versions of the new document, and/or to process information provided by a consumer which may allow previous versions of the new document to be located.

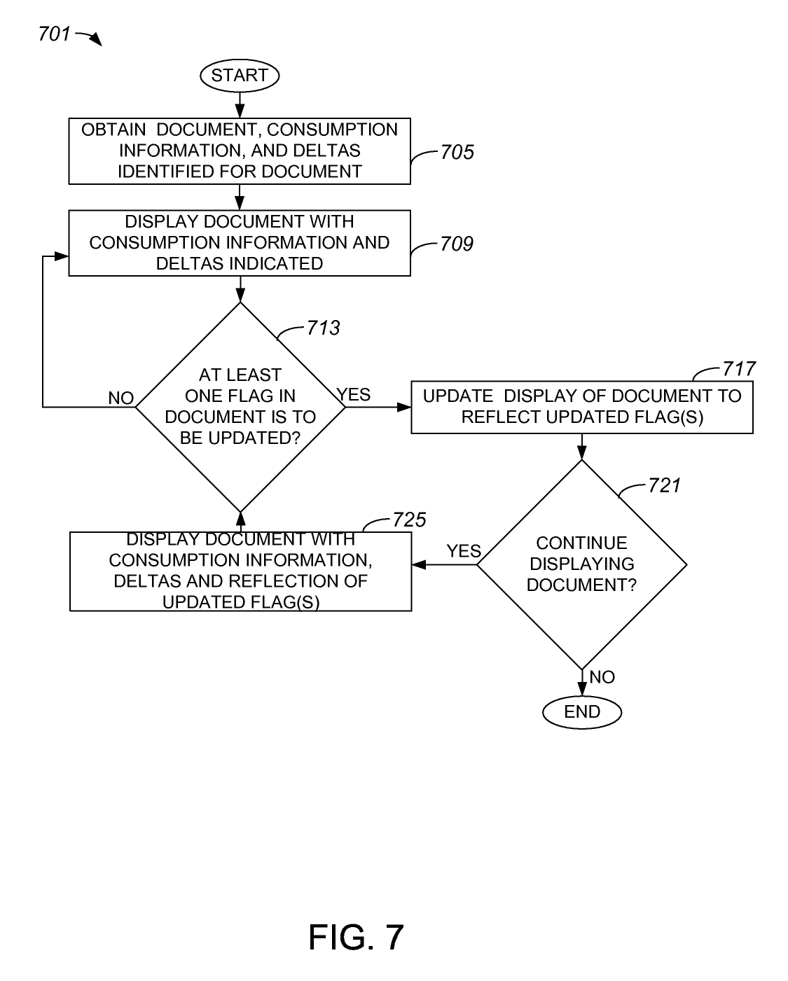

When a consumer opens a document which he or she has previously opened, the document may already have associated consumption information or deltas. For instance, such a document may include visual indications of whether different sections have previously been viewed. FIG. 7 is a process flow diagram which illustrates a method of generally presenting a document which has associated consumption information or deltas in accordance with an embodiment of the present invention. A process 701 of presenting a document which has associated consumption information and deltas begins at step 705 in which a document, consumption information associated with the document, and deltas identified for the document are obtained. The document is then displayed in step 709 with consumption information and deltas indicated. For example, the document may be displayed such that differences between the document and a previous version are visually highlighted.

Once the document is displayed, a consumer may interact with the document. Interacting with the document may include viewing the document and editing the document. A determination is made in step 713 as to whether interactions with the document are such that at least one flag in the document is to be updated. As will be appreciated by those skilled in the art, when at least one flag is to be updated, the indication is typically that a section of the document has been viewed, changed, and/or printed.

If it is determined in step 713 that at least one flag in the document is to be updated, the flag is updated, and the display of the document is updated to reflect the updated flag in step 717. For example, if a flag has been updated to indicate that a section has been viewed, the display of the document is updated to show that the section has been viewed. From step 717, process flow proceeds to step 721 in which it is determined whether the document is to continue to be displayed. If it is determined that the document is no longer to be displayed, e.g., if a consumer elects to close the document, then the process of presenting a document is completed.

Alternatively, if it is determined that the document is to continue to be displayed, then the document continues to be displayed in step 725. Process flow then returns to step 713 in which it is determined if at least one flag in the document is to be updated. If the determination in step 713 is that at least one flag in the document is not to be updated, then the document continues to be displayed in step 709 with consumption information and deltas indicated.

Although only a few embodiments of the present invention have been described, it should be understood that the present invention may be embodied in many other specific forms without departing from the spirit or the scope of the present invention. By way of example, while each section of a document has been described as having a plurality of associated flags which identify whether each section has been viewed, changed, or printed, each section of a document may instead include a substantially single indicator which identifies whether each section has been viewed, changed or printed. Such an indicator may include different values which correspond to different states associated with the section. For instance, the indicator may be set to one value when a section has not been viewed or changed, another value when the section has been viewed and changed, and to still another value when the section has been viewed but not changed.

As discussed above, different visualizations may be used to display different consumption statuses. In general, the different visualizations may vary widely. For example, a section that has been viewed but not changed may be shown as plain text, a section that has been viewed and changed may be shown with one color of highlight, and a section which has not been viewed or changed may be shown with another color of highlight.

A section of a document has generally been described as being identified as having been consumed, e.g., viewed or read, if the section has been displayed in a window of a display screen or if the section has been printed. Other criteria may also be used to determine when a section of a document has been consumed. Such criteria may include, but are not limited to including, determining whether a cursor has been moved over or within a section, and determining how much such a cursor has been moved.

In one embodiment, a scale may be assigned to indicate the quality with which a section of a document has been consumed. By way of example, a scale with values between zero and ten may be assigned such that a value of zero indicates that a section has effectively not been consumed, and a value of ten indicates that a section has likely been entirely consumed. With such a scale, a value of ten may be assigned if it is determined that the section has been heavily edited by a consumer, while a lower value may be assigned if it is determined that a cursor has been moved within the section, and an even lower value may be assigned if it is determined that the section has substantially only been displayed on a display screen. To visually indicate the quality of consumption when such a scale is implemented with respect to a section, the highlighting of the section in a visual display may vary depending upon the scale. For instance, a value of ten may be indicated by a dark shade of a color, while lower values may be indicated by lighter shades of the color. Alternatively, higher values may be indicated with more solid shades of a color, while lower values may be indicated by less solid shades of the color.

Generally, a consumer may control the visualization of deltas based on his or her preferences. A consumer of a document may be allowed to set parameters associated with the document which relate to whether a portion of a document is considered to be consumed. For example, a consumer of a document may set an amount of time a portion of the document is to be displayed on his or her display screen before the portion may be identified as having been consumed. If the portion has been displayed for the amount of time or longer, the portion may be flagged as having been viewed by the consumer. On the other hand, if the portion has been displayed for less than the amount of time, the portion may be flagged as not having been viewed by the consumer.

In one embodiment, an amount of time which has elapsed since a portion of a document has been consumed may be considered in determining whether the portion is to be “reset” as being unconsumed. That is, if a viewed portion of a document was viewed a relatively long time ago, that portion of the document may be flagged as being unviewed, as the consumer may benefit from rereading the portion. A consumer may set his or her overall system to flag a portion of a document which was consumed more than a month ago, for example, as effectively being unconsumed.

In general, a portion of a document which is tracked may be of any size. That is, the granularity with which a document may effectively be divided into portions, sections, or areas may vary widely. For example, a portion of a document that is tracked as a “tracking unit” may be as small as a single character, or may be as large as an entire document. Typically, a tracking unit may be a particular number of characters, a particular number of words, a particular number of sentences, a particular number of paragraphs, a particular number of pages, a particular number of chapters, or a particular number of lines.

While the size of sections within a document may be relatively uniform, it should be appreciated that a single document may include sections of different sizes. By way of example, while substantially all sections in a single document may be defined as being the length of a paragraph, sections may instead be defined within a single document such that some sections are the length of a paragraph, other sections are a particular number of lines, etc. In one embodiment, a creator or author of a document may manually define the size of each section within the document.

The display of deltas when a document is displayed may be substantially automatic. That is, deltas may be substantially automatically shown in a document when the document is opened. It should be appreciated, however, the display of deltas may instead be an option. Hence, in some instances, a consumer of the document may elect not to have deltas displayed when he or she opens a document.

In one embodiment, when a first user who has at least partially consumed a document forwards the document to a second user, the second user effectively sees a clean copy. That is, the second user does not see visual deltas in the document he/or she received. The second user does not see visual deltas in the document because the deltas, or differences and consumption information, are generally stored on a per-user basis.

The ability to track consumption may be arranged such that a reader is able to select whether or not to have deltas displayed. For example, a reader may select whether to display consumption information or to effectively hide consumption information.

The logic which provides functionality associated with the present invention may generally include hardware logic, software logic, or a combination of both hardware and software logic. Software logic may generally be encoded on a tangible media, and is operable to perform the various methods and steps associated with the present invention when executed.

The steps associated with the methods of the present invention may vary widely. Steps may be added, removed, altered, combined, and reordered without departing from the spirit of the scope of the present invention. Therefore, the present examples are to be considered as illustrative and not restrictive, and the invention is not to be limited to the details given herein, but may be modified within the scope of the appended claims.

What is claimed is:

1. A method comprising:
obtaining a first document, the first document including at least a first section;
displaying the first document on a display screen;
determining when the first section has been consumed, wherein determining when the first section has been consumed includes determining when the first section has been displayed on the display screen; and
providing an indication that the first section has been consumed if it is determined that the first section has been displayed on the display screen.

2. The method of claim 1 wherein providing the indication that the first section has been consumed includes setting at least one flag to indicate that the first section has been consumed.

3. The method of claim 2 wherein setting the at least one flag to indicate that the first section has been consumed includes setting the at least one flag to indicate that the first section has been viewed, printed, or changed.

4. The method of claim 1 wherein providing the indication that the first section has been consumed includes providing a visual indication that the first section has been consumed, the visual indication being provided when displaying the first document on the display screen.

5. The method of claim 4 wherein providing the visual indication includes highlighting at least part of the first section.

6. The method of claim 4 wherein the indication is associated with the first document such that when the first document is opened, the visual indication is displayed.

7. The method of claim 1 wherein the first section is one selected from the group including a character, a line, a sentence, a paragraph, a page, and a chapter of the first document.

8. The method of claim 1 wherein the first document is related to a second document, and the method further includes:
identifying the second document as being related to the first document;
identifying consumption information associated with the second document; and
updating the first document to include the consumption information, wherein displaying the first document on the display screen includes displaying the consumption information.

9. The method of claim 1 wherein the first document is related to a second document, and the method further includes:
identifying the second document as being related to the first document;
identifying at least one difference between the first document and the second document; and
updating the first document to identify the at least one difference, wherein displaying the first document on the display screen includes highlighting the at least one difference.

10. The method of claim 9 wherein the at least one difference is based on previous consumption information associated with the second document.

11. Logic encoded in one or more tangible media for execution and when executed operable to:
obtain a first document, the first document including at least a first section;
display the first document on a display screen;
determine when the first section has been consumed, wherein the logic operable to determine when the first section has been consumed includes logic operable to determine when the first section has been displayed on the display screen; and
provide an indication that the first section has been consumed if it is determined that the first section has been displayed on the display screen.

12. The logic of claim 11 operable to provide the indication that the first section has been consumed includes logic operable to set at least one flag to indicate that the first section has been consumed.

13. The logic of claim 12 wherein the logic operable to set the at least one flag to indicate that the first section has been consumed includes logic operable to set the at least one flag to indicate that the first section has been viewed, printed, or changed.

14. The logic of claim 11 wherein the logic operable to provide the indication that the first section has been consumed includes logic operable to provide a visual indication that the first section has been consumed, the visual indication being provided when the first document is displayed on the display screen.

15. The logic of claim 14 wherein the logic operable to provide the visual indication includes logic operable to highlight at least part of the first section.

16. The logic of claim 11 wherein the first section is one selected from the group including a character, a line, a sentence, a paragraph, a page, and a chapter of the first document.

17. The logic of claim 11 wherein the first document is related to a second document, and the logic is further operable to:
identify the second document as being related to the first document;
identify consumption information associated with the second document; and
update the first document to include the consumption information, wherein the logic operable to display the first document on the display screen includes logic operable to display the consumption information.

18. The logic of claim 11 wherein the first document is related to a second document, and the logic is further operable to:
identify the second document as being related to the first document;
identify at least one difference between the first document and the second document; and
update the first document to identify the at least one difference, wherein the logic operable to display the first document on the display screen includes logic operable to highlight the at least one difference.

19. An apparatus comprising:
means for obtaining a first document, the first document including at least a first section;
means for displaying the first document on a display screen;
means for determining when the first section has been consumed, wherein the means for determining when the first section has been consumed includes means for determining when the first section has been displayed on the display screen; and
means for providing an indication that the first section has been consumed if it is determined that the first section has been displayed on the display screen.

20. An apparatus comprising:
a display arrangement, the display arrangement being arranged to display at least a portion of a first document, the first document having a first representation of a first section;
an application, the application being arranged to allow the portion of the first document to be displayed, the application further being arranged to identify a second document, the second document being associated with the first document, the second document having a second representation of the first section, wherein the application is further arranged to determine when the second representation has been displayed on the display arrangement and to provide an indication in the first document that indicates that the first section has been consumed when it is determined that the second representation has been displayed on the display arrangement.

21. The apparatus of claim 20 wherein the second document is a previous version of the first document.

22. The apparatus of claim 21 wherein the application further includes a change tracking arrangement, the change tracking arrangement being arranged to identify a difference between the first document and the second document, the change tracking arrangement further being arranged to provide an indication of the difference in the first document.

23. The apparatus of claim 22 wherein the change tracking arrangement is arranged to set a flag to indicate the difference.

24. The apparatus of claim 20 wherein the indication that the first section has been consumed is an indication that the first section has been viewed or printed.

25. The apparatus of claim 24 wherein the application is further arranged to update at least one flag to indicate that the first section has been viewed or printed.

26. The apparatus of claim 20 wherein the indication in the first document that indicates that the first section has been consumed is a visual indication that the first section has been viewed.
